(19) United States
(12) Patent Application Publication
(10) Pub. No.: US 2024/0211837 A1
(43) Pub. Date: Jun. 27, 2024

(54) Systems, Methods, & Devices for Batching Work Tasks for Establishments

(71) Applicant: Oculogx Inc., Bentonville, AR (US)

(72) Inventors: Dylan Park, Bentonville, AR (US); Phillip Cannon, Fayetteville, AR (US); Charu Thomas, Fayetteville, AR (US); James Brent Sperry, Rogers, AR (US)

(21) Appl. No.: 18/087,301

(22) Filed: Dec. 22, 2022

(51) Int. Cl. G06Q 10/0631

(52) U.S. Cl. CPC G06Q 10/06316

(57) ABSTRACT

Examples include a computing system that (i) identifies a set of work tasks, wherein each work task in the set is associated with a plurality of task locations within an establishment, (ii) based on the set, generates a set of candidate combinations, wherein each candidate combination includes a plurality of work tasks from the set of work tasks, (iii) generates a set of optimization metrics, including determining, for each candidate combination, an optimization metric based on the plurality of task locations of each work task of the candidate combination, (iv) based on the set of optimization metrics, determines a set of optimized combinations comprising a subset of the set of candidate combinations that have been optimized for the establishment; and (v) causes, via a network interface, a computing device within the establishment to output an indication corresponding to an optimized combination from the set of optimized combinations.

### BACKGROUND

Online shopping has become a mainstay in everyday life. It is expected that 70% of U.S. consumers will regularly purchase goods online. From the perspective of a customer, the customer simply submits an order through the Internet, and after some amount of time passes, a package arrives at the customer's front door or the customer picks up the order at a brick-and-mortar store or the like. However, the intervening step of this apparently simple process—namely, personnel at a warehouse, retail establishment, etc. retrieving and assembling the goods for the order—accounts for a significant amount of time and resources spent by fulfillment establishments. Indeed, the fulfillment process (also referred to as “order picking”) accounts for over 50% of the annual costs spent on warehouse operations in the U.S. Many traditional distribution centers still use decades-old techniques to perform this process, and many retail fulfillment establishments are unable to adopt traditional distribution center innovations to improve similar operational tasks in-store.

### SUMMARY

In one aspect, the disclosed technology may take the form of a method carried out by a computing system that involves (i) identifying a set of work tasks, wherein each work task in the set of work tasks is associated with a plurality of task locations within an establishment, (ii) based on the set of work tasks, generating a set of candidate combinations, wherein each candidate combination comprises a plurality of work tasks from the set of work tasks, (iii) generating a set of optimization metrics, wherein generating the set of optimization metrics comprises, for each candidate combination from the set of candidate combinations, determining an optimization metric based on the plurality of task locations of each work task of the candidate combination, (iv) based on the set of optimization metrics, determining a set of optimized combinations comprising a subset of the set of candidate combinations that have been optimized for the establishment; and (v) causing at least one computing device within the establishment to output an indication corresponding to an optimized combination from the set of optimized combinations.

In some example embodiments, identifying the set of work tasks may involve identifying the set of work tasks based on one or more criteria for the establishment, wherein the one or more criteria includes one or more of (i) a work-task completion criteria, (ii) a work-task priority criteria, or (iii) a work-task availability criteria.

Further, in some example embodiments, each work task of the set of work tasks comprises (i) a fulfillment task comprising a series of two or more fulfillment actions for fulfilling orders, (ii) a replenishment task comprising a series of two or more replenishment actions for replenishing stock of one or more items at the establishment, or (iii) a mixed task comprising at least one fulfillment action and at least one replenishment action.

Further yet, in some example embodiments, for each candidate combination from the set of candidate combinations, determining the optimization metric based on the plurality of task locations of each work task of the candidate combination comprises determining the optimization metric based on one or more task locations that are not common to each work task of the candidate combination.

Still further, in some example embodiments, each candidate combination includes two work tasks from the set of work tasks, and generating the set of candidate combinations comprises generating the set of candidate combinations based on populating a multi-dimensional data structure with candidate combinations of two work tasks from the set of work tasks.

In some example embodiments, the multi-dimensional data structure comprises a metric entry for each candidate combination of two work tasks, and generating the set of optimization metrics comprises generating the set of optimization metrics based on populating, for each candidate combination of two work tasks, the metric entry with an optimization metric.

Further, in some example embodiments, the method further comprises identifying the at least one computing device based on the set of optimized combinations and one or more assignment priorities of the establishment.

Further yet, in some example embodiments, the method further comprises updating the set of optimized combinations based on receiving a completion status from one or more computing devices, wherein each completion status includes an indication of whether a particular optimized combination has been completed.

In another aspect, the disclosed technology may take the form of a computing system comprising (i) a network interface configured to communicatively couple the computing system to at least one computing device within an establishment, (ii) at least one processor, (iii) a non-transitory computer-readable medium, and (iv) program instructions stored on the non-transitory computer-readable medium that are executable by the at least one processor such that the computing system is configured to carry out the functions of the aforementioned method.

In yet another aspect, the disclosed technology may take the form of a non-transitory computer-readable medium, wherein the non-transitory computer-readable medium is provisioned with program instructions that, when executed by at least one processor, cause a computing system to carry out the functions of the aforementioned method.

It should be appreciated that many other features, applications, embodiments, and variations of the disclosed technology will be apparent from the accompanying drawings and from the following detailed description. Additional and alternative implementations of the structures, systems, non-transitory computer readable media, and methods described herein can be employed without departing from the principles of the disclosed technology.

### BRIEF DESCRIPTION OF THE DRAWINGS

FIG. 1 is a block diagram that illustrates an example network environment in which the disclosed technology for batching work tasks may be implemented;

FIG. 2 is a block diagram that illustrates an example network environment in which the disclosed technology for batching work tasks may be implemented;

FIG. 3 is a block diagram of an example wearable computing device, in accordance with the present disclosure;

FIG. 4A is a flow diagram of example operations of an example process that may be carried out in accordance with the present disclosure;

FIG. 4B is a flow diagram of example operations of an example process that may be carried out in accordance with the present disclosure;

FIG. 5A is a conceptual illustration of an example representation of a set of candidate combinations in accordance with the present disclosure;

FIG. 5B is a conceptual illustration of a set of optimization metrics that may be generated in accordance with the present disclosure;

FIG. 6A is a conceptual illustration to describe generation of a set of optimization metrics in accordance with the present disclosure;

FIG. 6B is a conceptual illustration to describe generation of a set of optimization metrics in accordance with the present disclosure;

FIG. 6C is a conceptual illustration of example operations that may be carried out in accordance with the present disclosure; and

FIG. 7 is a flow diagram of example operations of an example process that may be carried out in accordance with the present disclosure.

### DETAILED DESCRIPTION

The following disclosure refers to the accompanying figures and several example embodiments. One of ordinary skill in the art should understand that such references are for the purpose of explanation only and are therefore not meant to be limiting. Aspects of the disclosed embodiments may be rearranged, combined, added to, and/or removed in a variety of manners, each of which is contemplated herein.

### I. Brief Introduction

Most people are familiar with online shopping. A customer (i) creates an order that includes one or more items using a client device (e.g., a laptop, smartphone, tablet, etc.), (ii) submits the order using the client device via the Internet, and (iii) once the order has been fulfilled, either receives a delivery comprising the ordered items or picks up the ordered items from a brick-and-mortar store or the like.

Commonly, personnel (sometimes referred to as “pickers”) working at a warehouse, distribution center, or other establishment are assigned work tasks associated with orders to be fulfilled and often work to complete their assigned work tasks according to some prioritization (e.g., by shipping date, work-task complexity, etc.). In practice, a worker may be assigned a single work task (e.g., a “pick walk”) that requires the worker to stop at a sequence of locations within the establishment to retrieve (e.g., “pick”) an item and/or replenish stock of an item at the locations. Once the worker completes the assigned single work task, the worker usually is assigned a new work task for completion. This technique for assigning tasks to workers at a given establishment is generally inefficient, such as because it involves a large amount of time and distance traveled within the establishment for a given worker to complete tasks and often involves the given worker returning to, or passing by, the same locations within the establishment multiple times within a given shift.

Another technique for assigning tasks to workers at an establishment may involve combining two or more work tasks (e.g., two or more “pick walks”) into a single work task that a worker is to complete. Such a technique is sometimes referred to as “batching.” While batching techniques are generally better than the above-discussed single-task-assignment technique, there are nonetheless deficiencies in batching techniques. For instance, while batching techniques may improve upon inefficiencies for a single worker, batching techniques often do not account for the work status of an establishment as a whole. Moreover, establishments equipped with computing systems that monitor wearable computing devices utilized by workers to aid in completion of work tasks are faced with the technical challenge of incorporating batching techniques that can account for the real-time statuses of such wearable computing devices and/or real-time statuses of the establishment's orders, among various other dynamic variables.

Example embodiments provided herein seek to help address the deficiencies in existing work-assignment technology. To this end, in one aspect, a computing system is provided that intelligently combines work tasks for assignment to workers of a given establishment and deploys such work-task assignments to wearable computing devices utilized by the workers of the given establishment. Such a computing system provides advanced functionality not previously needed or otherwise performed when establishments utilized the above-discussed assignment techniques and provides a technological alternative to such techniques.

### Example Network Configuration

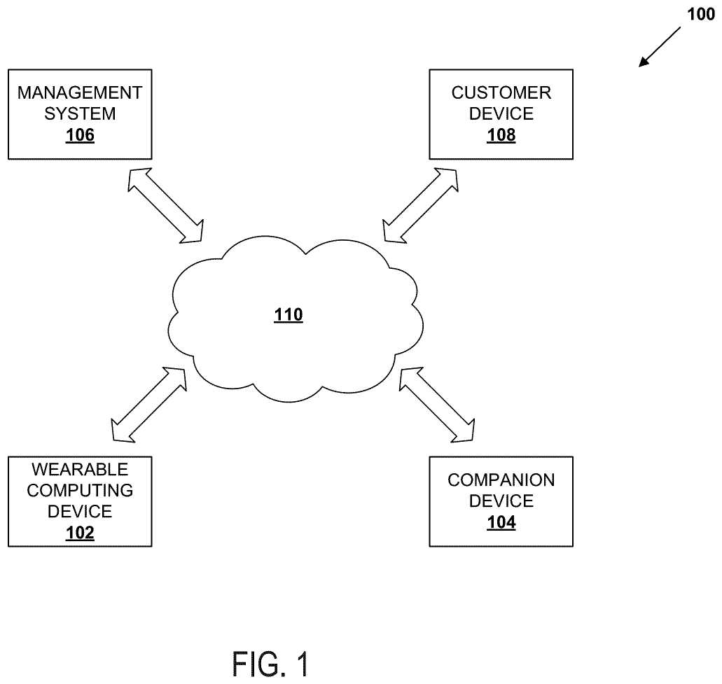

Turning now to FIG. 1, a simplified block diagram is provided that illustrates an example network environment in which the disclosed technology may be implemented. As shown, network configuration 100 includes one or more wearable computing devices 102, one or more corresponding companion devices 104, one or more management systems 106, and one or more customer devices 108, all of which may be communicatively coupled through one or more networks 110. In example implementations, some aspects of network configuration 100 may be located within an establishment, such as a warehouse, other distribution center, retail store, food establishment, etc. For instance, one or more wearable computing devices 102 and corresponding companion devices 104 may be located within the establishment, and management system 106 may also be wholly or partially located within the establishment or wholly or partially located remotely, such as at a remote server farm or the like. Other example arrangements are also possible.

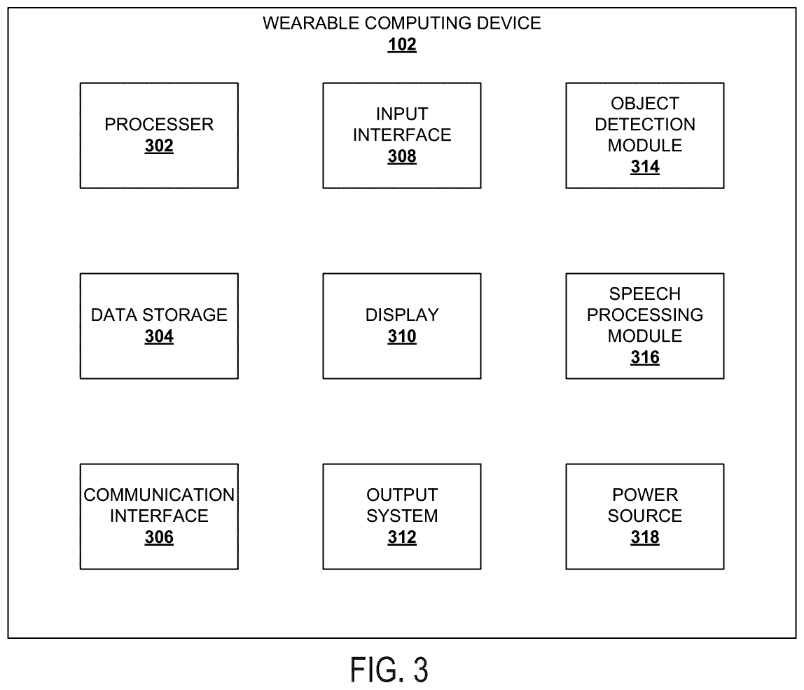

In practice, a worker may wear one or more wearable computing devices 102 to help facilitate the worker's work tasks. In general, wearable computing device 102 is designed such that a worker can operate wearable computing device 102 and utilize wearable computing device 102's functionality with limited user interaction. In this regard, at least some wearable computing devices 102 may permit “hands-free” operation in that a worker can perform various manual tasks with both hands while also leveraging the functionality of wearable computing device 102. Further, wearable computing devices 102 may be designed such that a user wearing a wearable computing device 102 may utilize the device to request work and/or report completion statuses of work assignments. Various types of wearable computing devices 102 may be utilized that augment a human-worker's abilities, such as a HUD device (sometimes referred to as a “head-mountable/mounted device” (HMD)). One example wearable computing device 102 is described in further detail below with reference to FIG. 3.

In some example embodiments, a worker equipped with wearable computing device 102 may also utilize one or more corresponding companion devices 104 that may be in communication with wearable computing device 102. In general, companion device 104 is configured to facilitate, supplement, and/or augment the functionalities of its corresponding wearable computing device 102. Various types of companion devices 104 are possible.

As one example, companion device 104 may take the form of a portable client device (e.g., a smartphone, tablet, etc.) with a software application stored thereon that is configured to control various aspects of wearable computing device 102 (e.g., via a Bluetooth connection between the two devices). In this example, the portable client device may also include additional and/or more advanced components that allow functions to be offloaded from wearable computing device 102. For instance, the portable client device may include additional and/or more advanced processing components, memory components, object-detection components, and/or speech-processing components compared to wearable computing device 102. Moreover, the portable client device may also be configured to communicate with management system 106 (e.g., via a wireless network interface or the like), perhaps on behalf of wearable computing device 102. Additional aspects of a portable client device are discussed below.

As another example, companion device 104 may take the form of a companion wearable computing device, such as a wearable radio frequency identification (RFID) detection device. Such a companion device may be configured to exchange information with wearable computing device 102 (or another companion device, such as a portable client device) after the companion device detects an RFID tag or the like that may be associated with a given item, a given storage bin for items, or a given location within an establishment. In one particular example, an RFID detection device may be designed in a manner such that it can be worn around a worker's wrist and configured to communicate with wearable computing device 102 directly or indirectly through a companion portable client device via one or more short-range communication paths (e.g., one or more Bluetooth communication paths). Other examples are also possible.

As yet another example, companion device 104 may take the form of a barcode scanner. The barcode scanner may be configured to scan an item's barcode or the like and then exchange information associated with that scan to wearable computing device 102 (e.g., via a Bluetooth connection between the two devices). In some implementations, wearable computing device 102 may itself be equipped with barcode scanning capabilities.

Other example types of companion devices 104 are possible. In example embodiments, multiple, different types of companion devices 104 may be communicatively coupled to a given wearable computing device 102. While in other embodiments, a given wearable computing device 102 may not be communicatively coupled to any companion device 104.

Broadly speaking, management system 106 may include one or more computing systems configured to facilitate monitoring, managing, and/or facilitating fulfillment of customer orders, as well as other tasks associated with the establishment, such as replenishment tasks, among others. To those ends, management system 106 may comprise one or more computing systems provisioned with software for performing one or more management system functions described herein, including but not limited to (i) receiving customer orders from customer devices 108, (ii) generating, identifying, and/or updating work tasks, (iii) generating work-task combinations, (iv) providing information to wearable computing devices 102 and/or companion devices 104, and (v) receiving information from wearable computing devices 102 and/or companion devices 104, among various other functions.

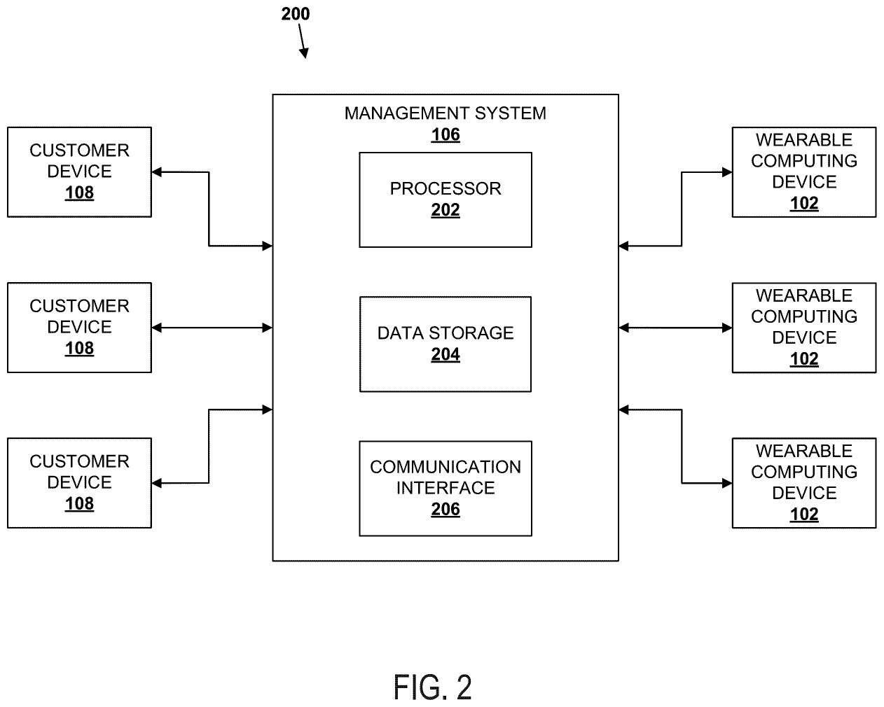

Management computing system 106 may take a variety of forms and be arranged in a variety of manners. As one possibility, management computing system 106 may include computing infrastructure that is wholly or partially located local to an establishment and may communicate with wearable computing devices 102 and/or companion devices 104 via one or more local area networks (LANs) 110 or the like and with customer computing devices 108 via one or more wide area networks (WANs) 110 or the like. As another possibility, management computing system 106 may include computing infrastructure that is wholly or partially located remote from an establishment (e.g., such a management computing system may be “cloud” based) and may communicate with wearable computing devices 102, companion devices 104, and/or customer computing devices 108 via one or more WANs 110 or the like. Other arrangements are also possible. Although not shown in FIG. 1, management computing system 106 may be communicatively coupled to various third-party computing systems that provide services that facilitate completing work tasks, such as third-party systems that generate fulfillment routes, third-party systems that perform object detection, and/or third-party systems that perform speech processing operations, among other possibilities. From a structural standpoint, management computing system 106 is discussed in further detail below in connection with FIG. 2.

In example cases, management system 106 may be configured to determine optimal combinations of work tasks for workers at a given establishment, and thus may comprise software and/or hardware that facilitates the operations discussed below. Moreover, management system 106 may be configured to facilitate object-detection functionality, and thus may comprise software and/or hardware that facilitates training object-detection models, executing object-detection models based on visual data from wearable computing devices 102, and/or deploying object-detection models to wearable computing devices 102. Further yet, management system 106 may be configured to facilitate speech-recognition functionality, and thus may comprise software and/or hardware that facilitates speech detection, natural language processing, and the like based on sound data captured by wearable computing devices 102 and/or companion devices 104. Management system 106 may be configured to perform various other functions as well, some of which are discussed below.

As mentioned before, customer devices 108 may generally be used by customers to submit online orders for goods. To that end, customer devices 108 may be configured with software and/or hardware to facilitate customer devices 108 communicating customer orders to management system 106. For instance, customer devices 108 may include one or more processors, one or more data storages, one or more communication interfaces (e.g., one or more wireless and/or wired network interfaces), and one or more input interfaces (e.g., mouse and keyboard, touchscreen, etc.) that are configured to receive user inputs related to assembling and submitting customer orders. Customer devices 108 may take various forms, such as different types of client devices (e.g., a desktop computer, laptop, smartphone, tablet, etc.), among other examples.

In practice, customer devices 108 may typically communicate with management system 106 via one or more WANs 110. In some instances, one or more customer devices 108 may be located at the establishment along with wearable computing devices 102 and/or management system 106, and/or may be communicatively coupled to a LAN 110 that wearable computing devices 102 and/or management system 106 are also coupled to. Other possibilities also exist.

As suggested before, data network 110 may include one or more data networks that facilitate communications between the various components depicted and/or described with reference to FIG. 1. The one or more data networks may be wired, wireless, or some combination thereof and may facilitate communications according to any of a variety of different communication protocols. Some particular examples of the one or more data networks may include one or more WANs (e.g., the Internet, cellular networks, etc.), LANs, personal area networks (PANs), and/or short-range links, among other possibilities.

Turning now to FIG. 2, a simplified block diagram is provided that illustrates an example network environment in which the disclosed technology for batching work tasks may be implemented. As shown, a network configuration 200 includes three customer devices 108, management system 106, and three wearable computing devices 102. Customer devices 108 and wearable computing devices 102 may be communicatively connected to management system 106 via one or more networks 110. Further, although three customer devices 108 and three wearable computing devices 102 are shown, network configuration 200 may comprise any number of such devices, and the example shown in FIG. 2 is intended to merely be illustrative of one possible implementation of network configuration 200.

As shown in FIG. 2, management system 106 may include one or more computing devices (e.g., one or more servers) that collectively comprise at least one processor 202, at leastat least one data storage 204, and at least one communication interface 206206, each of which are communicatively linked by a communication bus or another type of connection mechanism.

Processor 202 may comprise one or more processor components, which may take the form of general-purpose processors (e.g., microprocessors), special-purpose processors (e.g., application-specific integrated circuits, field-programmable integrated circuits, DSPs, GPUs, etc.), and/or controllers (e.g., microcontrollers), among other possibilities.

Data storage 204 may comprise one or more non-transitory, computer-readable mediums, which may take the form of volatile or non-volatile storage mediums, such as random-access memory, caches, buffers, read-only memory, flash memory, solid-state drives, or hard-disk drives, among other possibilities. Data storage 204 may comprise software that generally is in the form of program instructions that are executable by processor 202 such that management system 106 is capable of performing the management functions disclosed herein. Data storage 204 may include different databases or the like (e.g., a database of available work tasks, a database of optimized combinations of work tasks, etc.). In some implementations, management system 106 may store information to and/or retrieve information from one or more databases that are local to management system 106 (e.g., in data storage 204). In other implementations, management system 106 may store information to and/or retrieve information from one or more databases that are remote of management system 106.

Communication interface 206 may be configured to facilitate wired and/or wireless data communications with various data sources and data recipients, such as wearable computing devices 102, companion devices 104, customer devices 108, and/or other computing systems (not depicted). Examples of communication interface 206 may include an Ethernet interface, a serial bus interface, or a chipset and antenna configured for wireless communication (e.g., a Wi-Fi interface), among other possibilities.

Management system 106 may utilize processor 202, data storage 204, and communication interface 206, among other subsystems of management system 106 (not shown), to perform various functions. At a high level, such functions may include (i) receiving and storing one or more work tasks for an establishment (e.g., corresponding to outstanding customer orders for the establishment), (ii) identifying a set of work tasks of the establishment that are currently able to be performed by workers (e.g., a set of work tasks deemed the “active demand” of the establishment), (iii) generating combinations of work tasks for assignment to workers, (iv) assigning and transmitting combinations of work tasks to wearable computing devices 102, (v) receiving completion status reports from wearable computing devices 102 regarding assigned combinations of work tasks, and (vi) continuing to generate combinations of work tasks for assignment to workers based on completion status reports and/or customer orders, among other variables. Other functions of management system 106 are also possible.

### II. Example Wearable Computing Device

FIG. 3 depicts a simplified block diagram of an example implementation of wearable computing device 102. Although not depicted, in some implementations, wearable computing device 102 may include a framing structure that is designed to secure wearable computing device 102 to a wearer's head, such as an eyeglasses, goggles, or helmet structure, among other possibilities. Alternatively, wearable computing device 102 may be designed to secure to a wearer's arm, wrist, chest, or elsewhere. Wearable computing device's structure may house or otherwise comprise at least one processor 302, data storage 304, at least one communication interface 306, at least one input interface 308, at least one display 310, at least one output system 312, at least one object-detection module 314, and at least one speech-processing module 316, some or all of which are communicatively linked by a communication bus or another type of connection mechanism. Wearable computing device 102 also includes at least one power source 318 that provides power to a variety of the wearable computing device's other components, such as a rechargeable lithium-ion battery or the like.

Processor 302 may comprise one or more processor components that may take the form of general-purpose processors (e.g., microprocessors), special-purpose processors (e.g., application-specific integrated circuits, field-programmable integrated circuits, DSPs, GPUs, etc.), and/or controllers (e.g., microcontrollers), among other possibilities. Data storage 304 may comprise one or more non-transitory, computer-readable mediums that may take the form of volatile or non-volatile storage mediums (e.g., random-access memory, caches, buffers, read-only memory, flash memory, or solid-state drives), among other possibilities. Data storage 304 may comprise software that generally is in the form of program instructions that are executable by processor 302 such that wearable computing device 102 is capable of performing various functions disclosed herein.

Communication interface 306 may be configured to facilitate wired and/or wireless data communications with various data sources and data recipients, such as other wearable computing devices 102, companion devices 104, management system 106, and/or other computing systems not depicted in FIGS. 1-2. In example embodiments, communication interface 306 may include one or more communication interfaces that each take the form of a chipset and antenna configured for wireless communication, among other possibilities. In certain implementations, communication interface 306 may include at least one wireless communication interface configured according to a first communication protocol (e.g., according to one or more Wi-Fi communication protocols) and a second wireless communication interface configured according to a second communication protocol (e.g., according to one or more Bluetooth communication protocols). Other communication interfaces are possible as well.

Input interface 308 may include one or more input interfaces that are generally configured to receive, detect, and/or otherwise capture a stimulus originating external to wearable computing device 102 and then output information indicative of such stimulus to other components of wearable computing device 102. One or more of input interfaces 308 may take the form of a touch interface configured for touch inputs, such as a mechanical interface (e.g., a button, slider, switch, etc.) or a touch-sensitive interface (e.g., a capacitive or resistive touch surface, etc.), among other possibilities. One or more of input interfaces 308 may take the form of a visual-capture device, such as a camera that is configured to capture visual data (e.g., still images and/or video) corresponding to the wearable computing device's surroundings or another sensor configured to facilitate determining the position and/or movement of the wearable computing device's wearer's eyes, among other possibilities. One or more of input interfaces 308 may take the form of a sound-capture device, such as a microphone or microphone array configured to capture sound (e.g., speech commands) from the wearable computing device's surroundings, among other possibilities. One or more of input interfaces 308 may take the form of a HUD alignment sensor, such as an accelerometer, a gyroscope, a magnetometer, a light sensor, or some other sensor configured to facilitate (i) determining the wearable computing device's orientation, position, and/or location and/or (ii) interpreting the wearable computing device's wearer's head, arm, or body movements and the like, among other possible alignment sensors. Wearable computing device 102 may additionally or alternatively include other types of input interface.

Display 310 may include one or more display systems that are generally configured to output visualizations to the wearer of wearable computing device 102. In example embodiments, display 310 may include one or more lens elements comprising a material that facilitates displaying visualizations and allowing the wearer of wearable computing device 102 to see through the one or more lens elements. Display 310 may further include one or more projector units configured to project a visualization onto and/or through one or more lens elements. Display 310 may additionally or alternatively include one or more waveguides or other optical components that facilitate providing a visualization to one or more eyes of the wearer of wearable computing device 102. Further yet, display 310 may additionally or alternatively include one or more lasers, LEDs, or other light sources whose output may be steerable to provide a visualization to one or more eyes of the wearer of wearable computing device 102. In some implementations, wearable computing device 102 may include a single display (e.g., a monocular HUD) or two displays (e.g., a binocular HUD), among other possibilities.

Output system 312 may include one or more output systems that are generally configured to provide a sensory output to the wearer of wearable computing device 102. In this respect, display 310 is one example of output system 312. Other examples include (i) a sound output system that is configured to output audible and/or inaudible sound (e.g., one or more speakers, one or more amplifiers, one or more text-to-speech engines, one or more audio processors, etc.) or (ii) a haptic output system that is configured to output haptics (e.g., one or more vibrators or other actuators), among other possible examples.

In at least some implementations, wearable computing device 102 may be configured with object-detection functionality. To facilitate such functionality, object-detection module 314 may include one or more object-detection modules that facilitate wearable computing device 102 performing object detection locally, leveraging an external device to perform object detection on behalf of wearable computing device 102, or some combination thereof. For instance, in some implementations, object-detection module 314 may include (i) one or more object-detection models that receive as input visual data (e.g., images and/or video) from input interface 308 (e.g., a camera or the like) and output an indication of whether the visual data included at least one instance of an object that the model was trained to detect and/or (ii) one or more object-detection APIs that leverage object-detection functionality of another device, such as companion device 104, management system 106, a third-party service that performs object detection, etc. Other object-detection modules and/or object-detection arrangements are also possible. In some implementations, object-detection module 314 may be wholly or partially integrated with data storage 304.

In at least some implementations, wearable computing device 102 may be configured with speech-processing functionality. To facilitate such functionality, speech-processing module 316 may include one or more speech-processing modules that facilitate wearable computing device 102 locally performing speech processing on sound captured by input interface 308 (e.g., one or more microphones), leveraging an external device to perform speech processing on behalf of wearable computing device 102, or some combination thereof. For instance, in some implementations, speech-processing module 316 may include (i) one or more wake-word engines, (ii) one or more speech recognition engines, (iii) one or more natural language processors, and/or (iv) one or more speech-processing APIs that leverage speech-processing functionality of another device, such as companion device 104, management system 106, a third-party service that performs speech processing, etc. Other speech-processing modules and/or speech-processing arrangements are also possible. In some implementations, speech-processing module 316 may be wholly or partially integrated with data storage 304.

A person of ordinary skill in the art will appreciate that wearable computing device 102 of FIG. 3 is but one simplified block diagram of an example of a wearable computing device that could be utilized with the technology disclosed herein and should not be construed as limiting. For instance, the components of wearable computing device 102 may include additional components not illustrated, may have more or less of the illustrated components, and/or may have components arranged and/or integrated in different manners. Moreover, in example implementations, computing device 102 may not be wearable but may include some or all of the aforementioned components and functionality of computing device 102 described herein. In this regard, computing device 102 may take the form of a mobile computing device that is not designed to be secured to a user. Further still, in some implementations, some or all of the components and/or functionality of computing device 102 described herein may be integrated and/or implemented in a robot programmed to perform work tasks.

### III. Example Functions

In practice, an establishment (e.g., a warehouse, consumer retail store, etc.) is typically stocked with inventory that includes a variety of different items that are located throughout the establishment. The establishment typically has a respective code or the like (e.g., SKU) assigned to each unique item (e.g., package of goods) that helps facilitate tracking and monitoring the establishment's inventory (e.g., count of items that are stored at locations throughout the establishment). Each unique item may be stored in a respective location within the establishment, such as at a particular spot on a particular shelf that is down a particular aisle within a particular zone at the establishment. The establishment may have signage or the like on the zones, aisles, shelves, etc. that help facilitate locating the designated spots for each unique item.

In operation, establishment workers (e.g., “pickers”, “stockers,” etc.) may be responsible for various work tasks, such as fulfillment tasks for fulfilling (or “picking”) customer orders received by the establishment and replenishing tasks for replenishing stock of various items within the establishment (e.g., to facilitate future “picks”), among various other possibilities.

To complete assigned work tasks, an establishment worker typically uses an item-carrying tool that aids in the transport of items, which may take various forms. As one example, the item-carrying tool may take the form of a pushcart, basket, or the like that may include one or more item receptacles (e.g., bins, bags, etc.) that may be arranged in an item-receptacle array where the worker deposits retrieved items for fulfillment and/or withdraws items for replenishment (e.g., a 2×2, 3×3, 2×4, etc. array of item receptacles). As another example, the item-carrying tool may take the form of a pallet jack (which may be motorized or manually driven), forklift, or the like that may include one or more pallets on which the worker deposits retrieved items for fulfillment and/or withdraws items for replenishment. Other examples of item-carrying tools are also possible.

To help facilitate completing work tasks, the establishment may leverage aspects of network configuration 100 and/or network configuration 200. For instance, in example implementations, each establishment worker may wear a respective wearable computing device 102 and perhaps also utilizes one or more respective companion devices 104 to aid in completing work tasks.

For purpose of illustration only, example functions that may be carried out by (i) wearable computing device 102, (ii) management system 106, and/or (iii) customer device 108 associated with work tasks will be described in the context of example network configuration 100 of FIG. 1 and/or the context of example network configuration 200 of FIG. 2. To help describe some of these functions, flow diagrams may also be referenced to describe combinations of functions that may be performed. In some cases, each flow-diagram block may represent a module or portion of software code that includes program instructions that are executable by a processor to implement specific logical functions or steps in a process. The software code may be stored on any type of computer-readable medium, such as non-transitory, computer-readable media. Moreover, flow-diagram blocks may be rearranged into different orders, combined into fewer blocks, separated into additional blocks, and/or removed based upon the particular embodiment.

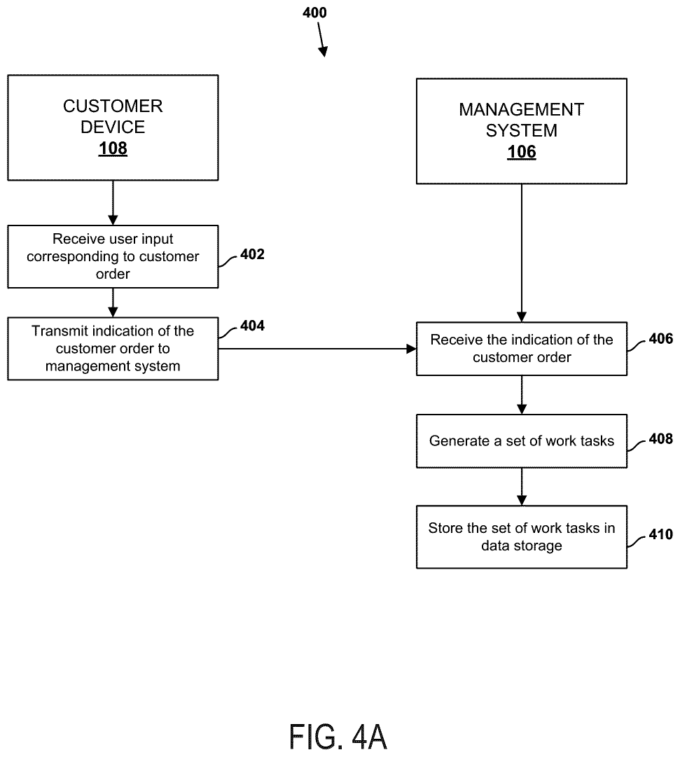

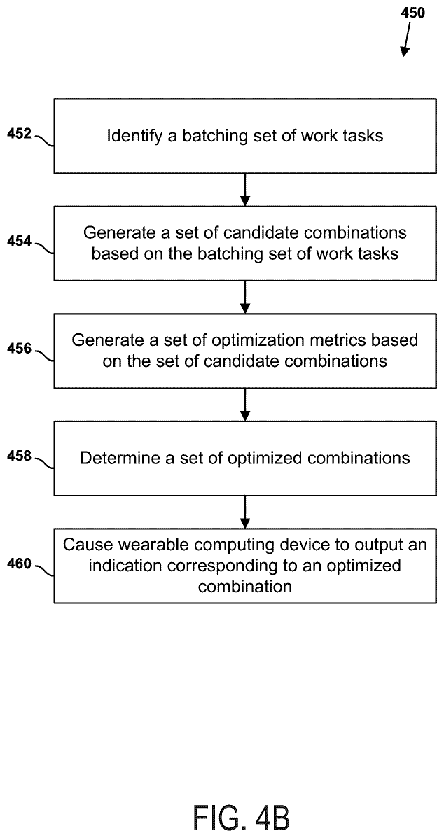

Turning now to FIG. 4A, a flow diagram 400 is provided that shows some example operations of an example process that may be carried out in accordance with the present disclosure.

As shown in FIG. 4A, the process may begin at block 402 with customer device 108 receiving user input corresponding to a customer order. In practice, customer device 108 may receive such user input via one or more input interfaces of customer device 108, such as a touchscreen, keyboard, etc. The user input may be provided by a user of customer device 108, such as a customer of an establishment or an online webpage associated with the establishment.

In practice, the user input corresponding to the customer order may identify customer order information. For example, customer order information may include information identifying (i) the customer (e.g., a customer's first and last name, email address, etc.), (ii) the types and amounts of items that the customer is ordering, and (iii) delivery details, such as a delivery address, a delivery date, and/or a delivery time (or window of time). Other customer order information is possible as well.

Turning to block 404, customer device 108 may transmit an indication of the customer order to management system 106. In practice, the indication of the customer order transmitted to management system 106 may include some or all of the customer order information discussed in block 402. This transmission may take the form of one or more messages (e.g., one or more HTTP messages) that are sent over network 110 between customer device 108 and management system 106. However, the transmission may take other forms as well.

As one illustrative example of blocks 402 and 404, a user may enter an online order via customer device 108 that in turn transmits an indication of such order via the Internet to management system 106.

At block 406, management system 106 may then receive the indication of the customer order that is sent by customer device 108. Further, in practice, management system 106 may receive indications of customer orders from various sources. For example, customer device 108 may be one of many customer devices (or other devices) that transmit indications of customer orders to management system 106.

Although not depicted in FIG. 4A, in addition to receiving indications of customer orders, management system 106 may further receive other information associated with the establishment. A first example of such information may take the form of replenishment information that generally reflects a particular area or location (e.g., item locations where pickers retrieve items for order fulfillment tasks) in the establishment where a given item is located that needs to be replenished with additional stock of that item. In practice, replenishment information may include information identifying (i) types and amounts of one or more items that are in need of being replenished, (ii) where to gather the one or more items for replenishing, and/or (iii) one or more locations to deposit the one or more items for replenishing the stock, among other possible replenishment information.

Management system 106 may receive replenishment information in various ways. As one possible example, the establishment's workers (e.g., pickers) may identify a depleting stock of one or more items stored at a location of the establishment where workers perform order fulfillment tasks and may transmit a request for replenishment, where the request may include replenishment information for the identified one or more items. In practice, the request may be transmitted to management system 106 through various devices, such as wearable computing devices 102 and/or companion device 104.

As another possible example, management system 106 may receive replenishment information that takes the form of information from which management system 106 infers that stock of one or more items stored at an area of the establishment where workers perform order fulfillment tasks is depleting. For instance, after a worker completes a fulfillment task, the worker's wearable computing device 102 and/or companion device 104 may transmit information indicative of the completed fulfillment task to management system 106. Such information may identify (i) the fulfillment task that was completed, (ii) one or more items and/or quantity of items that were picked, and/or (iii) one or more locations from which the one or more items were picked, among other possibilities. Based on such information, management system 106 may determine that stock of the one or more items is (i) below a threshold value or (ii) out-of-stock at the one or more locations where workers perform order fulfillment tasks. Management system 106 may receive replenishment information in other manners as well.

A second example of additional information associated with the establishment that management system 106 may receive may take the form of inventory information that generally reflects the establishment's currently stored inventory of a given item (e.g., in a back store or other inventory storage location of the establishment not traversed by workers performing fulfillment tasks). In practice, inventory information may include information identifying (i) types and amounts of one or more items currently stored in inventory and/or (ii) one or more inventory storage locations where the items are stored in inventory, among other possible inventory information.

Further, management system 106 may receive inventory information in various ways. As one possible example, a worker may identify a depleting inventory of one or more items stored at a location of the establishment where workers gather items for replenishment tasks as opposed to where workers complete fulfillment tasks (e.g., the inventory storage location of the establishment) and may transmit a request for refilling the inventory of the one or more items, the request including inventory information for the identified item(s). In practice, the request may be transmitted to management system 106 through various devices, such as wearable computing devices 102 and/or companion device 104.

As another possible example, management system 106 may receive inventory information that takes the form of information from which management system 106 infers that inventory of one or more items stored at the inventory storage location is depleting. For instance, after a worker completes a replenishment task, the worker's wearable computing device 102 and/or companion device 104 may transmit information indicative of the completed replenishment task to management system 106. Such information may identify (i) the replenishment task that was completed, (ii) one or more items and/or quantity of items that were gathered from the inventory of the establishment, and (iii) one or more inventory storage locations of the establishment where inventory of the items was located, among other possibilities. Based on such information, management system 106 may determine that inventory of one or more items are below a threshold value or depleted at the inventory storage location of the establishment. Management system 106 may receive inventory information in other manners as well.

At block 408, management system 106 may generate a set of work tasks based on received customer orders, replenishment information, and/or inventory information. The work tasks generated by management system 106 can take various forms.

In general, each work task generated by management system 106 is associated with a plurality of locations within the establishment where a worker is to complete an action (e.g., picking or re-stocking a particular quantity of a particular item). In this way, each work task may include a plurality of location-action pairs that each identify a particular action for a worker to complete at a particular location within the establishment.

In practice, a given work task may include a series of actions of the same type for a worker to complete or a mix of different types of actions for a worker to complete. For example, a given work task could take the form of a fulfillment task that includes a series of fulfillment (e.g., picking) actions for a worker for fulfilling orders, a replenishment task that includes a series of replenishment (e.g., re-stocking) actions for a worker for replenishing stock of one or more items at the establishment, or a mixed task that includes both fulfillment and replenishment actions for a worker.

In example embodiments, a fulfillment task may take the form of a data structure that identifies items and includes item information that facilitates fulfilling one or more customer orders. In at least some instances, a fulfillment task may include information for a plurality of unique items that correspond to multiple customer orders. While in some other instances, a fulfillment task may include information for a single customer order.

The included information for a given fulfillment task may comprise various pieces of information, including, for each item identified in the given fulfillment task: (i) a sequence number that may identify a position of the item in relation to other items of the given fulfillment task and generally defines the order in which a worker will be instructed to retrieve each item identified in the given fulfillment task, (ii) an item identifier that may uniquely identify the item, which may take the form of a description of the item (e.g., “Hefty Kitchen Trash Bags”), a code assigned to the item (e.g., a SKU, one or more UPCs, or the like), or data indicating a resource from which more information regarding the item can be obtained (e.g., a uniform resource identifier (URI) or the like for a graphics database comprising a graphic associated with the item), among other possible item identifiers, (iii) an item-location identifier, that may identify a particular location within the establishment, which may take the form of a description of the particular location (e.g., “Zone A—Aisle 5—Shelf 3—Spot 101”), a code assigned to the particular location (e.g., “J3-16-0471”), or coordinates within a map of the establishment, among other possible item-location identifiers, and (iv) an item quantity identifier, which may identify a number of instances of the item that is required (e.g., a numeric indication), among various other possible pieces of information. In practice, any of these identifiers (and any other identifier disclosed herein) may take the form of one or more (i) alphabetic, numeric, or alpha-numeric characters, (ii) symbols, and/or (iii) color indicators (among other possibilities) that help to distinguish one entity from another entity. U.S. Pat. No. 11,488,235 discloses an example of a fulfillment task and is herein incorporated by reference in its entirety.

In turn, a replenishment task may take the form of a data structure that includes item information that facilitates replenishing stock of one or more items located where workers perform fulfillment tasks. In at least some instances, a replenishment task may include information for a plurality of unique items. While in some other instances, a replenishment task may include information for a single unique item.

The included information for a given replenishment task may comprise various pieces of information, including, for each item identified in the given replenishment task: (i) a sequence number that may identify a position of the item in relation to other items of the given replenishment task and generally defines the order in which a worker will be instructed to deposit each item identified in the given replenishment task, (ii) an item identifier that may uniquely identify the item, which may take the form of a description of the item, a code assigned to the, or data indicating a resource from which more information regarding the item can be obtained, among other possible item identifiers, (iii) an item-location identifier that may identify a particular location within the establishment where the item is to be deposited, which may take the form of a description of the particular location, a code assigned to the particular location, or coordinates within a map of the establishment, among other possible item-location identifiers, (iv) an inventory-location identifier, that may identify a particular location within the establishment (e.g., the inventory storage location of the establishment) where the item may be retrieved for replenishment, and (v) an item quantity identifier, which may identify a number of instances of the item that is required (e.g., a numeric indication), among various other possible pieces of information. In practice, any of these identifiers may take the form of one or more (i) alphabetic, numeric, or alpha-numeric characters, (ii) symbols, and/or (iii) color indicators (among other possibilities) that help to distinguish one entity from another entity.

Likewise, a mixed task may take the form of a data structure that includes a mix of information described above for a fulfillment task and a replenishment task. In other words, the data structure for a mixed task may include at least one entry for a fulfillment action that includes information described above for a fulfillment task and at least one entry for a replenishment action that includes information described above for a replenishment task.

In practice, management system 106 may generate the set of work tasks in various ways. As one possible example, management system 106 may generate work tasks based on received customer orders, such that one or more work tasks are generated to fulfill received customer orders (e.g., from block 406). As another possible example, management system 106 may generate work tasks based on replenishment requests transmitted by workers of the establishment (e.g., in response to workers identifying a depleting stock of one or more items stored at a location of the establishment where workers perform order fulfillment tasks). As yet another possible example, management system 106 may generate work tasks based on determining that stock of one or more items is (i) below a threshold value or (ii) out-of-stock at the locations of the establishment where workers perform order fulfillment tasks. As another possible example, management system 106 may generate work tasks based on determining that inventory of one or more items is (i) below a threshold value or (ii) depleted at one or more inventory storage location of the establishment.

After management system 106 generates the set of work tasks, at block 410, management system 106 may store the set of tasks in data storage 206. As explained below, management system 106 may utilize such stored work tasks for batching purposes.

Turning now to FIG. 4B, a flow diagram 450 is provided that shows example operations of an example process that may be carried out in accordance with the present disclosure. For example, flow diagram 450 may be performed by management system 106 to facilitate batching tasks. As explained before, batching generally involves combining multiple, individual work tasks into a single work task for a worker to complete.

To that end, at block 452, management system 106 may identify a batching set of work tasks that define the universe of work tasks that management system 106 may batch into combinations of work tasks. In practice, management system 106 may identify the batching set of work tasks in a variety of manners. As one possibility, management system 106 may identify the batching set of work tasks by retrieving a set of work tasks previously stored by management system 106 (e.g., as described in connection with FIG. 4A). As another possibility, management system 106 may identify the batching set of work tasks based on one or more work-task criteria for the establishment.

In general, each work-task criteria corresponds to a characteristic or type of a work task that the establishment has designated as being of interest for batching (e.g., work tasks deemed the “active demand” of the establishment). Examples of work-task criteria include (i) a work-task completion criteria, (ii) a work-task priority criteria, and (iii) a work-task availability criteria, among other possibilities.

In example implementations, a work-task completion criteria indicates a date and/or time at which a work task is to be completed by (e.g., a ship-by-date by which a customer's order needs to be fulfilled, a cycle-time deadline at which certain items need to be cycled out of the establishment, etc.). For example, such a criteria can be used to identify work tasks that need to be completed within the next week, the next day, the next 8 hours, etc. or work tasks that need to be completed by a specific date, among other possibilities

In example implementations, a work-task priority criteria indicates a priority level that is associated with a work task (e.g., indicating a level of urgency of completing the work task or level of importance of the work task), such as high, medium, or low. For example, such a criteria can be used to identify work tasks that are considered the most important tasks or the least important tasks.

In example implementations, a work-task availability criteria indicates whether a work task is currently able to be completed by a worker. In this way, such a criteria can be used to identify work tasks that are ready and/or able to be assigned to a worker. For example, a work-task availability criteria for a fulfillment task may be based on whether one or more locations where workers perform fulfillment tasks has items in stock to be picked by a worker for completing the given fulfillment task. As another example, a work-task availability criteria for a replenishment task may be based on whether the items identified by the given replenishment task are (i) below a threshold amount in the locations where workers perform fulfillment tasks and/or (ii) above a threshold amount in the inventory storage location of the establishment.

In practice, management system 106 may identify the batching set of work tasks based on one or more work-task criteria for the establishment in various manners. As one possible implementation, management system 106 may retrieve a set of work tasks previously stored by management system 106 (e.g., as described in connection with FIG. 4A) and then identify a subset of that retrieved set by applying a filter or the like using one or more of the work-task criteria as filter parameters. The identified subset may then be designated the batching set of work tasks. As one concrete example, the batching set of work tasks may be identified by applying one or more filters to include only work tasks that (i) are currently able to be completed by a worker and (ii) have a shipping deadline within the next week. There may be various other filtering examples resulting in numerous possible batching sets of work tasks.

As another possible implementation, management system 106 may utilize the one or more work-task criteria to compile the batching set of work tasks from another database of available work tasks, such as a set of work tasks previously stored by management system 106 (e.g., as described in connection with FIG. 4A). For instance, instead of retrieving an entire set of work tasks and then utilizing the one or more work-task criteria to filter that retrieved set, management system 106 may utilize the one or more work-task criteria to retrieve a set of work tasks in the first instance. As one example, management system 106 may retrieve from a database of work tasks a first subset of work tasks that meet a first work-task criteria and a second subset of work tasks that meet a second work-task criteria and then designate the combination of the first and second subsets as the batching set of work tasks.

Management system 106 may identify the batching set of work tasks in other manners as well.

Returning to FIG. 4B, at block 454, management system 106 may generate a set of candidate combinations based on the batching set of work tasks from block 452. In example implementations, each candidate combination of the set of candidate combinations may include a plurality of work tasks from the batching set of work tasks. In practice, the number of work tasks included in a candidate combination may differ depending on the implementation.

As one possible implementation, each candidate combination in the set of candidate combinations may include the same number of work tasks. As one specific example, each candidate combination may include a pair of work tasks (i.e., two work tasks) from the batching set of work tasks, and the generated set of candidate combinations may include all possible pairs of work tasks from the batching set of work tasks. In this example, the universe of candidate pairs can be represented by a two-dimensional data structure, such as a two-dimensional matrix or array.

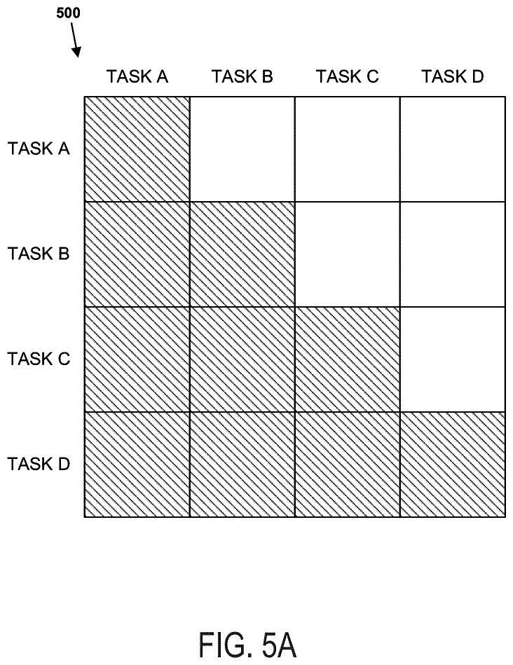

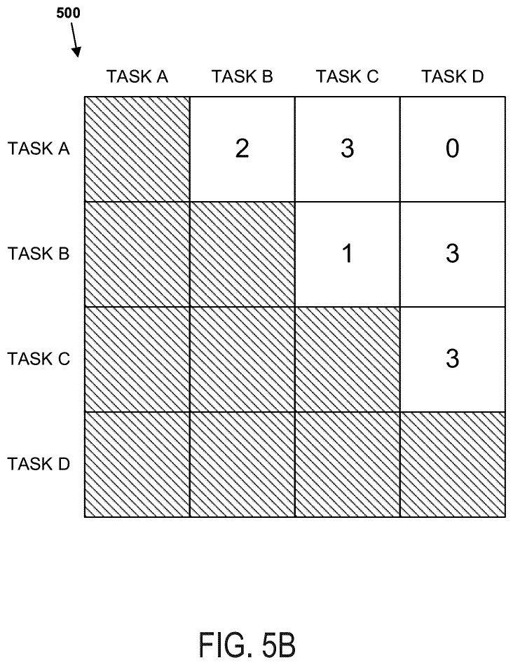

FIG. 5A illustrates one example of a representation of a set of candidate combinations in accordance with the present disclosure. In FIG. 5A, an example matrix 500 is shown representing one way in which management system 106 may combine pairs of work tasks into candidate pairs. As may be seen, a horizontal axis of matrix 500 lists out four tasks (TASK A, TASK B, TASK C, and TASK D), and a vertical axis of matrix 500 lists out the same four tasks. The horizontal and vertical axes intersect at matrix cells that comprise every possible combination of pairs of work tasks from the set of four work tasks. As shown, this is one example of how management system 106 may populate a two-dimensional data structure (e.g., matrix 500) with candidate combinations of two work tasks from the batching set of work tasks to generate the set of candidate combinations. Other examples may exist.

Although not shown in FIG. 5A, in practice, the number of work tasks that may comprise a candidate combination may be any number and is not limited to pairs. For example, each candidate combination may contain 3 works tasks, or 4 work tasks, among various other fixed amounts of work tasks. In such examples, management system 106 may generate the set of candidate combinations utilizing an approach similar to that described above but with a three-dimensional, four-dimensional, or other multi-dimensional matrix.

As another possible implementation, some candidate combinations in the set of candidate combinations may include a different number of work tasks than other candidate combinations in the set of candidate combinations. As one example, one candidate combination of the set of candidate combinations may include a pair of work tasks, while another candidate combination of the set of candidate combinations may include a triplet of work tasks (i.e., three work tasks), among various other examples. As another example, some candidate combinations of the set of candidate combinations may include a single work task, other candidate combinations may include a pair of work tasks, and yet other candidate combinations may include a triplet of work tasks, among various other examples. In such implementations, any number of work tasks may be batched into a candidate combination.

In practice, management system 106 may generate the set of candidate combinations in various manners.

For example, in implementations where each candidate combination includes the same number of work tasks, management system 106 may generate a multi-dimensional (e.g., two-three-, etc. dimensional) data structure, such as a matrix, array, or the like, whose number of dimensions corresponds to the number of individual work tasks that make up a given candidate combination. For instance, if each candidate combination of the set of candidate combinations comprises a pair of work tasks, then the data structure is a two-dimensional data structure, whereas if each candidate combination of the set of candidate combinations comprises three work tasks, then the data structure is a three-dimensional data structure. Other examples are also possible.

Moreover, management system 106 may then utilize the batching set of work tasks (e.g., from block 452) to populate the generated multi-dimensional data structure in a manner that removes any candidate combinations of work tasks that are not viable. For instance, returning to FIG. 5A, matrix cells corresponding to pairs of work tasks that are not viable candidates (e.g., pairs that are redundant or that include pairing one task with itself) have been filled in to eliminate such pairs, including: (i) pairs of the same work task (e.g., a pairing for TASK A and TASK A) and (ii) duplicate work-task pairs (e.g., a work task pair for TASK A and TASK B may be retained in matrix 500, whereas a work task pair for TASK B and TASK A may be removed as a redundancy). In practice, identifying candidate combinations of work tasks that are not viable may occur at runtime.

Based on the populated multi-dimensional data structure, management system 106 may then identify viable combinations and designate such combinations as the set of candidate combinations. For instance, based on matrix 500 of FIG. 5A, management system 106 may generate a set of candidate pairs that includes pairs that have not been eliminated from matrix 500 including: (i) a candidate pair for TASK A and TASK B, (ii) a candidate pair for TASK A and TASK C, (iii) a candidate pair for TASK A and TASK D, (iv) a candidate pair for TASK B and TASK C, (v) a candidate pair for TASK B and TASK D, and (vi) a candidate pair for TASK C and TASK D. In FIG. 5A, these viable candidate pairs correspond to matrix cells that are blank or otherwise not filled in. In some instances, management system 106 may not eliminate candidate combinations of work tasks that are not viable at block 454 but instead, may perform this function at block 458.

As another example manner by which management system 106 may generate the set of candidate combinations, in implementations where each candidate combination includes the same number of work tasks, management system 106 may utilize a combination algorithm that generates all unique possible combinations of n elements from a set of elements, where n is set to the number of work tasks included in each candidate combination and the elements are the individual work tasks from block 452. Example combination algorithms might include any known k-combination algorithm, among other possibilities.

Further, in example implementations where some candidate combinations comprise different numbers of work tasks than other candidate combinations, management system 106 may utilize the batching set of work tasks and generate the set of candidate combinations by iteratively applying one or more of the above approaches. For example, in instances where some candidate combinations comprise 2 work tasks and other candidate combinations comprise 3 work tasks, management system 106 may (i) generate a set of all possible viable pairs of work tasks using one of the above-discussed approaches, (ii) generate a set of all possible viable triplets of work tasks using one of the above-discussed approaches, and (iii) aggregate the two sets as the set of candidate combinations.

Moreover, in example implementations where some candidate combinations comprise different numbers of work tasks than other candidate combinations, management system 106 may utilize the batching set of work tasks and generate the set of candidate combinations utilizing one or more data structures, such as matrices, arrays, or the like that account for the variable number of work tasks. For example, in some implementations, multiple data structures of different dimensions may be utilized. For instance, in an implementation where candidate combinations may comprise up to three work tasks, a one-dimensional data structure (e.g., matrix), a two-dimensional data structure, and plural (e.g., three) three-dimensional data structures may be utilized. Other examples are also possible.

Returning to FIG. 4B, at block 456, management system 106 may generate a set of optimization metrics based on the set of candidate combinations from block 454. In example implementations, an optimization metric may indicate a particular metric by which the establishment seeks to optimize completion of work tasks. Example optimization metrics may indicate (i) distance traveled by a worker to complete a candidate combination of work tasks, (ii) number of stops taken by a worker to complete a candidate combination of work tasks, (iii) time required for a worker to complete a candidate combination of work tasks, (iv) number of overlapping (e.g., shared) stops to complete a candidate combination of work tasks, (v) number of non-overlapping (e.g., non-shared) stops to complete a candidate combination of work tasks, (vi) total degree of overlapping paths taken by a worker to complete a candidate combination of work tasks, (vii) total degree of non-overlapping paths taken by a worker to complete a candidate combination of work tasks, (viii) proximity of work-tasks locations for a candidate combination of work tasks, (ix) an item category or classification associated with a candidate combination of work tasks, (x) a total item weight and/or volume associated with a candidate combination of work tasks, and (xi) a relationship between work-task completion dates (e.g., the difference of days between when work tasks of a candidate combination must be completed by), among other possibilities.

In practice, an optimization metric may take various forms. As one example, an optimization metric may comprise a single metric (e.g., numerical value) reflecting a quality of a given candidate combination (e.g., a number of stops a worker will need to take to complete the work tasks of the given candidate combination, an amount of time it is expected to take a worker to complete the work tasks of the given candidate combination, or any of the other examples discussed above).

As another example, an optimization metric may comprise a composite metric made up of (ii) two or more individual metrics, each reflecting a respective quality of a given candidate combination (e.g., each of a different metric type), and perhaps (ii) one or more weighting factors applied to one or more of the individual metrics, among various other possibilities. For example, a composite metric for each candidate combination could include a first metric reflecting a number of steps that are required to complete the given candidate combination (perhaps weighted by a first weighting factor) and a second metric reflecting a number of stops a worker will need to take to complete the given candidate combination (perhaps weighted by a second weighting factor that is different from the first weighting factor). Other examples are also possible. In some instances, a value function may be utilized to generate a composite metric, where the value function takes plural inputs (e.g., plural individual metrics) and outputs the composite metric.

Further, in practice, optimizing the completion of work tasks may be defined in numerous ways. As one example, optimizing the completion of work tasks may correspond to minimization of a particular optimization metric. For instance, optimizing the completion of work tasks may seek to identify the minimum amount of time required to complete work tasks or the minimum number of non-overlapping stops required to complete work tasks. As another example, optimizing the completion of work tasks may correspond to maximization of an optimization metric. For instance, optimizing the completion of work tasks may seek to identify the maximum amount of overlap between travel paths and/or picking locations traversed to complete work tasks. Other examples are also possible.

In practice, management system 106 may generate the set of optimization metrics in various manners. As one possibility, generating the set of optimization metrics may involve, for each candidate combination from the set of candidate combinations from block 454, determining an optimization metric based on the plurality of task locations of each work task of the candidate combination. For example, management system 106 may determine an optimization metric for a given candidate combination based on identifying any task locations (or stops) that are shared by two or more work tasks of the given candidate combination and/or identifying any task locations (or stops) that are not shared by two or more work tasks of the given candidate combination. In this way, management system 106 may determine an optimization metric for a given candidate combination based on evaluating whether, and to what extent, task locations (or stops) are common to each work task in the given candidate combination.

FIG. 5B provides one example illustration of a set of optimization metrics generated by management system 106, in accordance with the present disclosure. Matrix 500 may include a metric entry for each of the candidate pairs, where each metric entry may be populated with an optimization metric for a corresponding candidate pair. Accordingly, the metric entries of the candidate pairs of matrix 500 may represent the set of optimization metrics generated by management system 106. In implementations, optimization metrics of the set of optimization metrics may be represented as scores (e.g., numerical values). As shown, the candidate pair comprising TASK A and TASK B has a metric entry populated with a score of 2, the candidate pair comprising TASK A and TASK C has a metric entry populated with a score of 3, the candidate pair comprising TASK A and TASK D has a metric entry populated with a score of 0, the candidate pair comprising TASK B and TASK C has a metric entry populated with a score of 1, the candidate pair comprising TASK B and TASK D has a metric entry populated with a score of 3, and the candidate pair comprising TASK C and TASK D has a metric entry populated with a score of 3. In implementations, the scores may be based on the locations of the TASKS A-D.

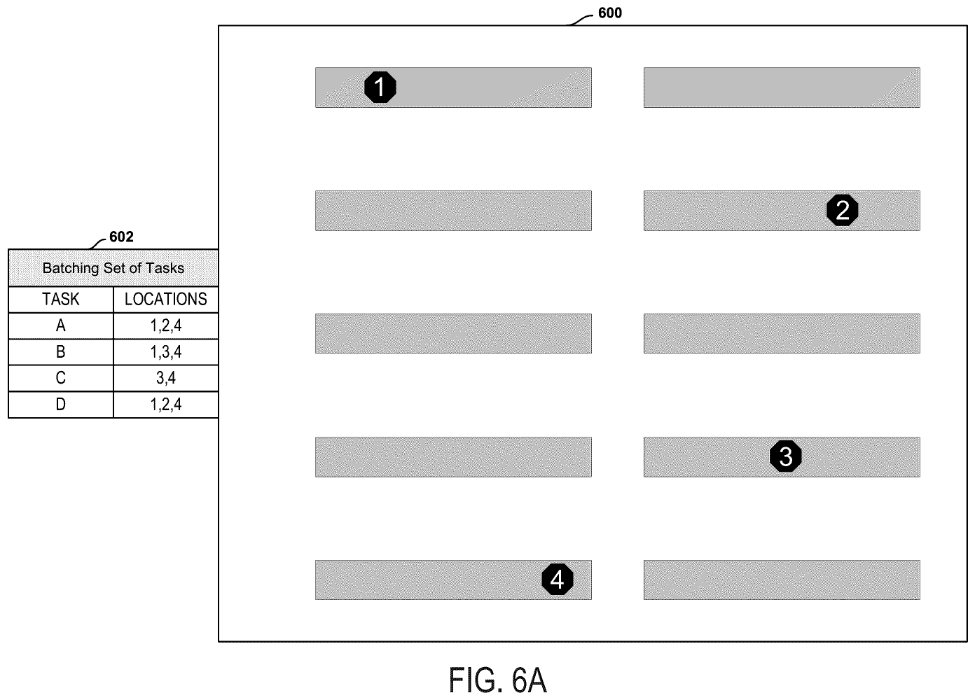

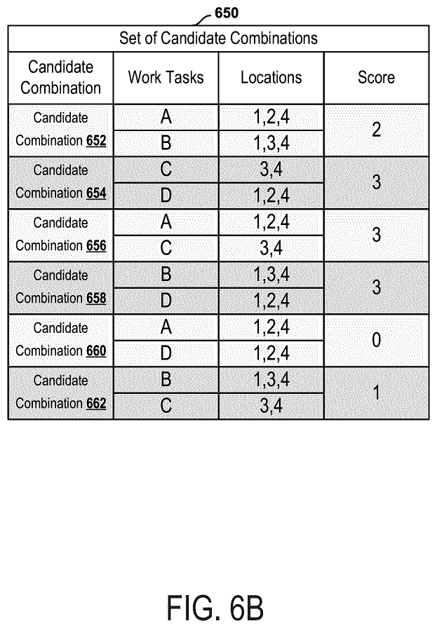

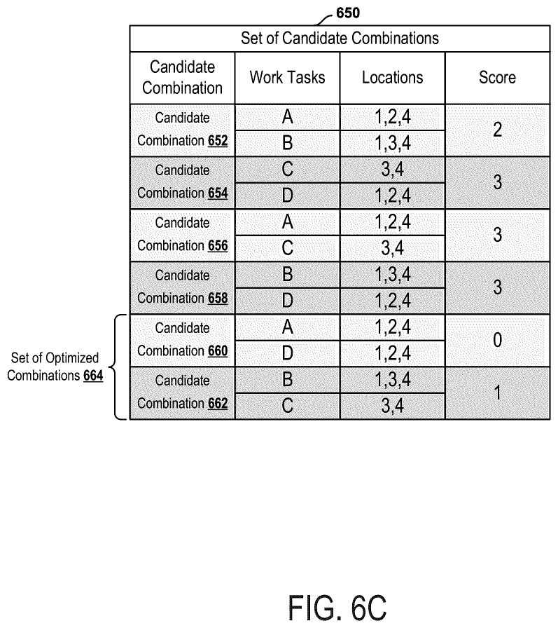

FIGS. 6A-6B provide example conceptual illustrations to describe how management system 106 may have generated the set of optimization metrics illustrated in FIG. 5B based on the task locations corresponding to each candidate combination, in accordance with the present disclosure.

Starting with FIG. 6A, an example establishment 600 is shown comprising various locations (labeled as 1, 2, 3, and 4) that signify where a worker is to stop to perform a work-task action (e.g., item pick or item replenishment) within example establishment 600. Further, a batching set of tasks 602 that may have been generated by management 106 is shown including tasks A, B, C, and D (e.g., the same tasks from FIGS. 5A-5B), each task comprising item-location identifiers identifying the locations within example establishment 600 where work-task actions are to occur. As shown, (i) task A comprises item-location identifiers identifying the locations 1, 2, and 4, (ii) task B comprises item-location identifiers identifying the locations 1, 3, and 4, (iii) task C comprises item-location identifiers identifying the locations 3 and 4, and (iv) task D comprises item-location identifiers identifying the locations 1, 2, and 4.

Turning now to FIG. 6B, a set of candidate combinations 650 generated by management system 106 based on the tasks A-D of FIG. 6A is shown including a number of candidate combinations representing every possible pairing of the tasks A-D. As shown, a candidate combination 652 comprises the pair of tasks A and B, a candidate combination 654 comprises the pair of tasks C and D, a candidate combination 656 comprises the pair of tasks A and C, a candidate combination 658 comprises the pair of tasks B and D, a candidate combination 660 comprises the pair of tasks A and D, and a candidate combination 662 comprises the pair of tasks B and C.

As shown, each of candidate combinations 652-662 comprises a score, each of which may be based on one or more attributes of work tasks of the given candidate combination 652-662. As one possibility, a score may at least be partially based on the respective locations corresponding to the applicable candidate combination. In the example of FIG. 6B, the score for each candidate combination may be determined by adding the number of instances where a location (or stop) is not shared between work tasks of the applicable candidate combination. For example, because work tasks of candidate combination 652 do not share locations 2 and 3 (e.g., task A requires location 2 while task B does not, and task B requires location 3 while task A does not), the score for candidate combination 652 is determined to be 2. The other candidate combinations 654-662 may have their respective scores generated in a similar fashion. Taken together, the scores of candidate combinations 652-662 may comprise the set of optimization metrics generated by management system 106.

As another possibility, a score may be at least partially based on a particular establishment policy and a respective measure of a given candidate combination's impact on that particular establishment policy. As one example, an establishment policy may take the form of a reorder policy that establishes a stock threshold for at least one item located at (i) the establishment as a whole or (ii) a particular location of the establishment (e.g., a location where workers perform order fulfillment tasks), where the stock threshold dictates when (i) a respective inventory for the at least one item is reordered for the establishment as a whole (e.g., management system 106 submits a reorder to a wholesale distributor, importer, etc.) or (ii) a respective inventory for the at least one item is set to be replenished at the particular location of the establishment. In such examples, management system 106 may be configured to determine scores of candidate combinations based on how the completion of the work tasks of the candidate combinations affect the stock level of an item relative to the stock threshold established by the reorder policy. Accordingly, in some instances, candidate combinations that bring the stock level of the item closest to the stock threshold established by the reorder policy may have a higher score than candidate combinations that do not bring the stock level of the item as close to the stock threshold established by the reorder policy. In practice, a reorder policy could apply to some or all items within the establishment and/or the stock threshold could be the same or different for the applicable items within the establishment (e.g., the stock threshold value could be the same for all items within the establishment, one item could have a first stock threshold value that is lower than a second item's stock threshold value, etc.). Other possible examples of establishment policies may also exist.

Other attributes of work tasks of the given candidate combination 652-662 may also impact a score. For example, other attributes may include (i) the types of items that are associated with a candidate combination (e.g., a score may be higher when all items in a candidate combination are frozen grocery items compared to when there is a mix of frozen and unfrozen items), (ii) the sizes of items that are associated with a candidate combination (e.g., a score may be higher when all items in a candidate combination are of the same or similar size compared to when there is a mix of sizes or a score may be higher when the aggregate volume of all items in a candidate combination does not exceed a size threshold compared to when the aggregate volume exceeds the size threshold), and (iii) the weights of items that are associated with a candidate combination (e.g., a score may be higher when all items in a candidate combination are of the same or similar weight compared to when there is a mix of weights or a score may be higher when the aggregate weight of all items in a candidate combination does not exceed a weight threshold compared to when the aggregate volume exceeds the weight threshold), among numerous other examples.

It should be noted that the example methodology for generating scores based on the number of instances where a location (or stop) is not shared between work tasks of a given candidate combination is merely one possible methodology for generating a set of optimization metrics. Indeed, there may be many methods for generating a set of optimization metrics based on locations of candidate combinations. For example, scores of respective candidate combinations may be determined in accordance with any of the above discussed examples of optimization metrics, among various other possibilities. In this regard, while a score may be directly determined from the locations corresponding to the candidate combinations, scores for certain optimization metrics may instead be indirectly determined from the locations corresponding to the candidate combinations. For instance, a score reflecting time required for a worker to complete a candidate combination of work tasks may be estimated based on the locations corresponding to the candidate combinations, such as by taking an average amount of time for an average worker to travel to such locations. In other instances, scores of respective candidate combinations may be based on the work tasks themselves. For instance, an attribute or the like of a work task other than the work task's location may be utilized to derive a score. Further, when multiple attributes or the like of a work task are utilized to derive a score (e.g., when the score is derived based on both respective locations corresponding to work tasks of the candidate combinations and how the completion of the work tasks of the candidate combinations align with a policy of the establishment, such as how the completion of the work tasks of the candidate combinations affect the stock of one or more items relative to a threshold stock established by a reorder policy of the establishment), the various attributes may be scaled according to some weighing system, which may prioritize certain attributes over others. Other examples are also possible.

Returning to FIG. 4B, at block 458, management system 106 may determine, based on the set of optimization metrics from block 456, a set of optimized combinations that include a subset of the set of candidate combinations that have been optimized for the establishment.

In practice, management system 106 may employ any of various optimization algorithms to determine the set of optimized combinations. For example, an optimization algorithm may take the form of a minimization algorithm that operates on an input multi-dimensional data structure (e.g., a 2-dimensional matrix) and outputs a fully (or partially) completed solution. As another example, an optimization algorithm may take the form of a maximization algorithm that operates on an input multi-dimensional data structure (e.g., a 3-dimensional matrix) and outputs a fully (or partially) completed solution. As yet another example, an optimization algorithm may take the form of a GNU Linear Programming Kit (GLPK) solver that utilizes PuLP, a Gurobi solver, or a Tabu Search solver. As yet further examples, an optimization algorithm may take the form of a branch and bound algorithm (e.g., where the algorithm may selectively travel through various nodes of a tree representing the various candidate combinations to identify, based on the optimization metrics of the nodes, a travel path that represents the set of optimized combinations), a particle swarm algorithm, or any other algorithm that may prioritize consideration of various candidate combinations according to a given scheme.

To implement a given optimization algorithm, management system 106 may (i) input the set of optimization metrics corresponding to the set of candidate combinations, (ii) run the given optimization algorithm on the set of candidate combinations based on the set of optimization metrics, and then (iii) receive an output from the given optimization algorithm that reflects the set of optimized combinations. For example, the output may take the form of an ordered listing of optimized combinations that are listed in order of highest to lowest optimization metric or listed in order of lowest to highest optimization metric, which may depend on the type of the optimization metric being utilized. In other examples, the output may take the form of an unordered listing of the optimized combinations of the set of optimized combination.

In example implementations, management system 106 may be configured to run a given optimization algorithm until a complete (or global) solution is identified. For example, management system 106 may execute an optimization algorithm and have it examine each candidate combination of the set of candidate combinations based on the set of optimized metrics to identify a set of optimized combinations that accounts for each work task in the batching set of work tasks (e.g., from block 452).

Additionally or alternatively, management system 106 may be configured to run a given optimization algorithm until a partial (or local) solution is identified. For example, management system 106 may execute an optimization algorithm, have it examine each candidate combination of the set of candidate combinations based on the set of optimized metrics until the optimization algorithm reaches a particular solution threshold, and then utilize the solution that the optimization algorithm had identified at that point as the set of optimized combinations. In example implementations, a solution threshold could take the form of a metric indicating a degree of completion, such as a percentage of completion or an amount of time that the optimization algorithm has been executing, among various other possibilities.

FIG. 6C illustrates one example of operations that management system 106 may perform to determine the set of optimized combinations based on the set of optimization metrics. From the set of candidate combinations 650, management system 106 may identify a set of optimized combinations 664, according to any of the described optimization algorithms.

As seen, the scores (e.g., optimization metrics) for candidate combinations 660 and 662 are “0” and “1,” respectively. As may be seen, the sum of these scores is lower than the respective sums of the scores any of the other candidate combinations 652-658. In implementations where a low score indicates a more optimal combination, management system 106 may identify the set of candidate combinations 660 and 662 and designate them as the set of optimized combinations 664, which, at least in this example, is also globally optimized (e.g., accounts for each work task from the batching set of work tasks 602).

On the other hand, the scores for candidate combinations 656 and 658 are “3” and “3,” respectively. As may be seen, the sum of these scores is higher than the respective sums of the scores any of the other candidate combinations 652-654, 660-662. In implementations where a high score indicates a more optimal combination, management system 106 may identify the set of candidate combinations 656 and 658 and designate them as the set of optimized combinations, which, at least in this example, is also globally optimized (e.g., accounts for each work task from the batching set of work tasks 602).

In some implementations, management system 106 may determine the set of optimized combinations called for by block 458 further based on one or more constraints of the establishment. In practice, such constraints can take various forms.

One possible constraint may set bounds on the number of work tasks that may be combined together (e.g., only pairs, no more than 3 work tasks may be batched into any given candidate combination, etc.). Another possible constraint may be that there are no duplicate work tasks in optimized combinations of the set of optimized combination. Yet another possible constraint may be that every work task in the batching set of work tasks be included in an optimized combination of the set of optimized combinations. Further, there may be various other constraints that impact how management system 106 determines the set of optimized combinations.

In practice, management system 106 executing one or more optimization algorithms in accordance with one or more constraints of the establishment may result in various candidate combinations not being examined and/or not included in the set of optimized candidates. For instance, management system 106 may implement an optimization algorithm such that it examines only candidate combinations that conform with the constraints of the establishment (e.g., if one constraint of the establishment is that only pairs of work tasks are to be batched into combinations, then candidate combinations of other sizes may not be examined further) and identify the set of optimized combinations from the candidate combinations that conform with the constraints of the establishment based on the set of optimization metrics.

Returning to FIG. 4B, at block 460, management system 106 may cause at least one wearable computing device 102 within the establishment to output an indication corresponding to an optimized combination from the set of optimized combinations determined at block 458. Management system 106 may perform this function by sending over one or more networks 110 data indicative of an optimized combination of the set of optimized combinations to wearable computing device 102 for completion by a worker of the establishment.

Management system 106 may determine which optimized combination of the set of optimized combinations to send, as well as which wearable device 102 to send the optimized combination to, based on one or more assignment priorities of the establishment. In general, an assignment priority may reflect an attribute associated with a combination of work tasks that the establishment has designated as being indicative of a combination of work tasks that should be completed as soon as possible or otherwise, before other combinations of work tasks that do not have that attribute. In this regard, an assignment priority may correspond to a given work-task criteria discussed before in connection with block 452. In some implementations, an assignment priority may additionally or alternatively reflect an attribute associated with a worker that is to complete a combination of work tasks.

In certain embodiments, an example assignment priority may take the form of (i) a combination completion priority, (ii) a combination priority level, or (iii) a preferred worker priority, among various other priorities of the establishment.

In example implementations, a combination completion priority may correspond to a work-task completion criteria discussed in connection with block 452. For instance, a combination completion priority may indicate a date and/or time at which a combination of work tasks is to be completed by.

In example implementations, a combination priority level may correspond to a work-task priority criteria discussed in connection with block 452. For instance, a combination priority level may indicate a priority level that is associated with a combination of work tasks (e.g., indicating a level of urgency of completing the combination or level of importance of the combination), such as high, medium, or low.

In example implementations, a preferred worker priority may indicate a preferred worker type, or even a specific worker at the establishment, for a given optimized combination. For example, interns, temps, or other inexperienced workers of the establishment may be prioritized for simpler or less urgent optimized combinations, while more experienced workers may be prioritized for more difficult or more urgent optimized combinations. As another example, workers may be preferred based on their location, such as their proximity to items in given work tasks.

Further, although management system 106 has been described as utilizing assignment priorities of the establishment, in implementations, such assignments may not be utilized by management system 106. For instance, management system 106 may send data indicative of an optimized combination of the set of optimized combinations to a given wearable computing device 102 based on a user request, for example, by a worker outfitted with wearable computing device 102. Further yet, management system 106 may determine which optimized combination of the set of optimized combinations to send, as well as which wearable device 102 to send the optimized combination to, based at least partially on a given worker's current location within the establishment (e.g., as measured by the location of the given worker's wearable device 102).

Based on management system 106 sending data indicative of an optimized combination to wearable computing device 102, wearable computing device 102 may be caused to output an indication corresponding to the optimized combination. In practice the indication may take various forms.

As one possibility, the indication may take the form of a visual indication. For instance, the visual indication may direct a worker outfitted with wearable computing device 102 to begin completing the optimized combination, such as by indicating, via maps, images, textual descriptions, etc., where to pick up items for fulfillment, where to deposit items for replenishment, what items to pick up/deposit, etc. In some implementations, such a visual indication may be portrayed on a HUD display, in implementations where wearable computing device 102 comprises an HUD.

As another possibility, the indication may take the form of an audible indication verbally directing a worker outfitted with wearable computing device 102 to begin completing the optimized combination.

As yet another possibility, the indication may take the form of a haptic indication or other sensory indication notifying a worker of the optimized combination. Moreover, in example implementations, the indication can include one or multiple different types of indications (e.g., the indication could include both an audible and visual notification). U.S. Pat. No. 11,488,235 discloses some examples of indications that a wearable computing device can be caused to output and is herein incorporated by reference in its entirety.

It should be noted that although block 460 has been described with respect to a single wearable computing device 102, in practice, management system 106 may perform the operations of block 460 with respect to multiple wearable computing devices 102 at the same time or at different times, by sending a unique optimized combination to each wearable computing device 102, for example, according to any assignment priorities of the establishment.

Further, it should be noted that management system 106 may perform some or all of blocks 452-460 of flowchart 450 at various times, which it may do periodically (e.g., daily, every 3 hours, etc.) or aperiodically (e.g., based on a trigger). For example, a worker submitting a request for work may trigger management system 106 to perform one or more of blocks 452-460 to provide an optimized combination for the worker. As another example, management system 106 may perform one or more of blocks 452-460 as directed by the establishment (e.g., via a computing device of a manager or the like of the establishment), for example to provide optimized combinations to workers identified by the establishment. As yet another example, management system 106 may perform one or more of blocks 452-458 in the background, for example to maintain an updated set of optimized combinations as workers complete optimized combinations, as new orders (e.g., fulfillment or replenishment) come in, as inventory levels of certain items of the establishment changes, and so forth. As yet a further example, management system 106 may be configured to perform some or all of blocks 452-460 of flowchart 450 upon completion of a previous execution of some or all of blocks 452-460. For instance, management system 106 may be configured to execute block 452 (and subsequently, block 454-460 in sequence) upon completion of block 458 and/or block 460.

In this way, management system 106 may be enabled to dynamically determine a set of optimized combinations and/or readily transmit an optimized combination to a given wearable computing device 102, rather than needing to perform each of blocks 452-460 every time management system 106 receives a request from a wearable computing device for an assignment. Further, this may enable management system 106 to more regularly transmit globally optimized combinations, as management system 106 will be more likely to have sufficient time to identify a globally optimized set of combinations before assigning optimized combinations to wearable computing device 102.

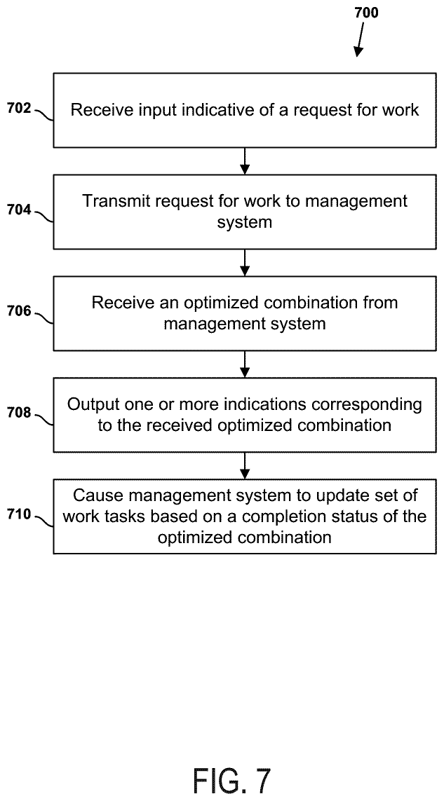

Turning now to FIG. 7, a flow diagram 700 shows example operations of another example process that may be carried out in accordance with the present disclosure, for example by wearable computing device 102.

The process may begin at block 702, where wearable computing device 102 may receive input indicative of a request for work. The input may indicate that a worker is seeking work and/or is to be assigned work and may include, among various other things, an identity of a worker. Further, the input may be received in various ways. As one possibility, a worker may transmit the input to wearable computing device 102, for example, via audible instructions or physical interactions with one or more input interfaces of wearable computing devices 102, among other examples.

Then, at block 704, wearable computing device 102 may transmit the request for work to management system 106. In practice, this transmission may take the form of one or more messages (e.g., one or more HTTP messages) that are sent over network 110 between wearable computing device 102 and management system 106. However, the transmission may take other forms as well.

Next, at block 706, wearable computing device 102 may receive an optimized combination from management 106, as described in FIG. 4B.

Although not depicted, in some instances, wearable computing device 102 may receive an optimized combination from management system 106 without having performed either of blocks 702 or 704. For example, work tasks may be assigned and transmitted to various wearable computing devices 102 by management system 106 in response to a request from a computing system of the establishment for work tasks to be distributed to one or more wearable computing devices of the establishment, perhaps without the prompting of a request for work from wearable computing device 102.

Then, at block 708, wearable computing device 102 may output one or more indications corresponding to the received optimized combination. For instance, wearable computing device 102 may output one or more visual, audible, and/or haptic indications to a user (e.g., a worker of the establishment outfitted with wearable computing device 102) that serve to guide the user to perform the actions (e.g., picking and/or re-stocking items) of the optimized combination. As previously described, this may include outputting an indication corresponding to the optimized combination to direct the user to begin and/or continue completing the optimized combination.

In implementations where wearable computing device 102 includes a display, the indication may take the form of a sequence of visualizations portrayed to the user via the display. In practice, each visualization may take various forms and may include a variety of information. In example embodiments, each visualization may include one or more of (i) a visual indication of a particular item that is to be picked (e.g., for a fulfillment task) or deposited (e.g., for a replenishment task), (ii) a visual indication of a particular item location within the establishment, and/or (iii) a visual indication of a quantity of the particular item, among other possible visualization elements. U.S. Pat. No. 11,488,235 describes an example of how such visualizations may guide a worker to complete a given work task, and as previously mentioned, is incorporated by reference in its entirety.

In practice, the sequence of visualizations may portray instructions for each item in each work task of the optimized combination and thus, may guide the user to perform the optimized combination to completion. Further, although the block 708 has been described in the context of visualizations portrayed on a display, wearable computing device 102 may perform the block 708 in a variety of ways. For example, the indication may take the form of a sequence of audible directions to the user, where each audible direction provides verbal instructions describing (i) a particular item that is to be picked (e.g., for a fulfillment task) or deposited (e.g., for a replenishment task), (ii) a particular item location within the establishment (e.g., comprising directions to the particular item location such as “turn left now” or “turn right ahead at Marker A27-20-0012” or the like), and/or (iii) a quantity of the particular item, among other possible verbal instructions to guide the user to perform the optimized combination to completion. Yet other forms of the indication are also possible that may guide the user to perform the optimized combination to completion.

In practice, there may be instances where the user is unable to complete the optimized combination as expected. As one example, it may be possible that an item location expected to have enough stock of a given item for the user to pick for a given work task of the optimized combination may in fact not have enough stock of the given item. In response, wearable computing device 102 may identify an alternate location that does have sufficient stock of the given item and may direct the user to that location instead. However, if there are no alternate locations with sufficient stock of the given item, then the user may not be able to complete the given work task of the optimized combination. In response, wearable computing device 102 may (i) instruct the user to continue attempting to complete other work tasks of the optimized combination, (ii) send a request or prompt the user to send a request to management system 106 for a new work task (e.g., a new replenishment task to replenish stock of the given item) to be generated, and/or (iii) terminate a performance of the optimized combination. There may be various other examples of instances where the user is unable to complete the optimized combination as expected, including replenishment work tasks unable to be complete due to (i) a lack of inventory of items requested for replenishment and/or (ii) an unexpectedly sufficient stock of items at locations in the establishment that were identified for replenishment, among various other examples.

Wearable computing device 102 may determine a completion status of the optimized combination based on whether the user was able to perform the optimized combination to completion. In implementations, the completion status may indicate (i) that the optimized combination was performed to completion, (ii) that one or more of the work tasks of the optimized combination were completed, and/or (iii) that one or more of the work tasks of the optimized combination were unable to be completed, among other possibilities.

Returning to FIG. 7, at block 710, wearable computing device 102 may cause management system 106 to update the set of work tasks based on the completion status of the optimized combination. To initiate this, wearable computing device 102 may report the completion status of the optimized combination to management system 106, for example, by sending network data indicative of the completion status to management device 102 via network 110.

Upon receipt of the completion status, management system 106 may analyze the completion status, along with any other network data sent from wearable computing device 102 (e.g., requests for new work tasks), and update the set of work tasks (e.g., the batching set of work tasks from block 452 of FIG. 4B) accordingly. For instance, updating the set of work tasks may involve (i) removing completed work tasks from the set of work tasks, (ii) retaining incomplete work tasks within the set of work tasks, and/or (iii) adding new work tasks to the set of work tasks based on an analysis of the set of work tasks in view of the received completion status (e.g., by adding a replenishment task to restock items in locations where an optimized combination was not performed to completion successfully), among various other possibilities.

Although not depicted, wearable computing device 102 may cause management system 106 to update the set of work tasks based on other information. For example, wearable computing device 102 may transmit requests to management system 106 for work tasks to be added to the set of work tasks, which management system 106 may receive and, accordingly, update the set of work tasks based on the request.

Further, as noted before, management system 106 may be caused to perform various functions based on the received completion status of the optimized combination, such as any of the functions described in connection with one or more of blocks 452-460 of FIG. 4B. In this way, management system 106 may update and refine the set of optimized combinations so as to continuously store and be ready to provide an optimized combination of a globally optimized (or at least locally optimized) set of optimized combinations to wearable computing devices 102 in the establishment.

### VI. Conclusion

Example embodiments have been described above. Those skilled in the art will understand, however, that changes and modifications may be made to the embodiments described without departing from the true scope and spirit of the present invention, which will be defined by the claims.

Further, to the extent that examples described herein involve operations performed or initiated by actors, such as “humans,” “pickers,” “workers,” “personnel,” “users” or other similar entities, this is for purposes of example and explanation only. The claims should not be construed as requiring action by such actors unless explicitly recited in the claim language.

1. A computing system comprising:
a network interface configured to communicatively couple the computing system to at least one computing device within an establishment;
at least one processor;
a non-transitory computer-readable medium; and
program instructions stored on the non-transitory computer-readable medium that are executable by the at least one processor such that the computing system is configured to:
identify a set of work tasks, wherein each work task in the set of work tasks is associated with a plurality of task locations within the establishment;
based on the set of work tasks, generate a set of candidate combinations, wherein each candidate combination comprises a plurality of work tasks from the set of work tasks;
generate a set of optimization metrics, wherein generating the set of optimization metrics comprises, for each candidate combination from the set of candidate combinations, determining an optimization metric based on the plurality of task locations of each work task of the candidate combination;
based on the set of optimization metrics, determine a set of optimized combinations comprising a subset of the set of candidate combinations that have been optimized for the establishment; and
cause, via the network interface, the at least one computing device within the establishment to output an indication corresponding to an optimized combination from the set of optimized combinations.

2. The computing system of claim 1, wherein the program instructions that are executable by the at least one processor such that the computing system is configured to identify the set of work tasks comprise program instructions that are executable by the at least one processor such that the computing system is configured to:
identify the set of work tasks based on one or more criteria for the establishment, wherein the one or more criteria comprises one or more of (i) a work-task completion criteria, (ii) a work-task priority criteria, or (iii) a work-task availability criteria.

3. The computing system of claim 1, wherein each work task of the set of work tasks comprises (i) a fulfillment task comprising a series of two or more fulfillment actions for fulfilling orders, (ii) a replenishment task comprising a series of two or more replenishment actions for replenishing stock of one or more items at the establishment, or (iii) a mixed task comprising at least one fulfillment action and at least one replenishment action.

4. The computing system of claim 1, wherein, for each candidate combination from the set of candidate combinations, determining the optimization metric based on the plurality of task locations of each work task of the candidate combination comprises determining the optimization metric based on one or more task locations that are not common to each work task of the candidate combination.

5. The computing system of claim 1, wherein each candidate combination comprises two work tasks from the set of work tasks, and wherein the program instructions that are executable by the at least one processor such that the computing system is configured to generate the set of candidate combinations comprise program instructions that are executable by the at least one processor such that the computing system is configured to:
generate the set of candidate combinations based on populating a multi-dimensional data structure with candidate combinations of two work tasks from the set of work tasks.

6. The computing system of claim 5, wherein the multi-dimensional data structure comprises a metric entry for each candidate combination of two work tasks, and wherein the program instructions that are executable by the at least one processor such that the computing system is configured to generate the set of optimization metrics comprise program instructions that are executable by the at least one processor such that the computing system is configured to:
generate the set of optimization metrics based on populating, for each candidate combination of two work tasks, the metric entry with an optimization metric.

7. The computing system of claim 1, further comprising program instructions stored on the non-transitory computer-readable medium that are executable by the at least one processor such that the computing system is configured to:
identify the at least one computing device based on the set of optimized combinations and one or more assignment priorities of the establishment.

8. The computing system of claim 1, further comprising program instructions stored on the non-transitory computer-readable medium that are executable by the at least one processor such that the computing system is configured to:
update the set of optimized combinations based on receiving a completion status from one or more computing devices, wherein each completion status comprises an indication of whether a particular optimized combination has been completed.

9. A non-transitory computer-readable medium, wherein the non-transitory computer-readable medium is provisioned with program instructions that, when executed by at least one processor, cause a computing system to:
identify a set of work tasks, wherein each work task in the set of work tasks is associated with a plurality of task locations within an establishment;
based on the set of work tasks, generate a set of candidate combinations, wherein each candidate combination comprises a plurality of work tasks from the set of work tasks;
generate a set of optimization metrics, wherein generating the set of optimization metrics comprises, for each candidate combination from the set of candidate combinations, determining an optimization metric based on the plurality of task locations of each work task of the candidate combination;
based on the set of optimization metrics, determine a set of optimized combinations comprising a subset of the set of candidate combinations that have been optimized for the establishment; and
cause the at least one computing device within the establishment to output an indication corresponding to an optimized combination from the set of optimized combinations.

10. The non-transitory computer-readable medium of claim 9, wherein the program instructions that, when executed by at least one processor, cause the computing system to identify the set of work tasks comprise program instructions that, when executed by at least one processor, cause the computing system to:
identify the set of work tasks based on one or more criteria for the establishment, wherein the one or more criteria comprises one or more of (i) a work-task completion criteria, (ii) a work-task priority criteria, or (iii) a work-task availability criteria.

11. The non-transitory computer-readable medium of claim 9, wherein each work task of the set of work tasks comprises (i) a fulfillment task comprising a series of two or more fulfillment actions for fulfilling orders, (ii) a replenishment task comprising a series of two or more replenishment actions for replenishing stock of one or more items at the establishment, or (iii) a mixed task comprising at least one fulfillment action and at least one replenishment action.

12. The non-transitory computer-readable medium of claim 9, wherein, for each candidate combination from the set of candidate combinations, determining the optimization metric based on the plurality of task locations of each work task of the candidate combination comprises determining the optimization metric based on one or more task locations that are not common to each work task of the candidate combination.

13. The non-transitory computer-readable medium of claim 9, wherein each candidate combination comprises two work tasks from the set of work tasks, and wherein the program instructions that, when executed by at least one processor, cause the computing system to generate the set of candidate combinations comprise program instructions that, when executed by at least one processor, cause the computing system to:
generate the set of candidate combinations based on populating a multi-dimensional data structure with candidate combinations of two work tasks from the set of work tasks.

14. The non-transitory computer-readable medium of claim 13, wherein the multi-dimensional data structure comprises a metric entry for each candidate combination of two work tasks, and wherein the program instructions that, when executed by at least one processor, cause the computing system to generate the set of optimization metrics comprise program instructions that, when executed by at least one processor, cause the computing system to:
generate the set of optimization metrics based on populating, for each candidate combination of two work tasks, the metric entry with an optimization metric.

15. A method carried out by a computing system, the method comprising:
identifying a set of work tasks, wherein each work task in the set of work tasks is associated with a plurality of task locations within an establishment;
based on the set of work tasks, generating a set of candidate combinations, wherein each candidate combination comprises a plurality of work tasks from the set of work tasks;
generating a set of optimization metrics, wherein generating the set of optimization metrics comprises, for each candidate combination from the set of candidate combinations, determining an optimization metric based on the plurality of task locations of each work task of the candidate combination;
based on the set of optimization metrics, determining a set of optimized combinations comprising a subset of the set of candidate combinations that have been optimized for the establishment; and
causing, the at least one computing device within the establishment to output an indication corresponding to an optimized combination from the set of optimized combinations.

16. The method of claim 15, further comprising:
identifying the set of work tasks based on one or more criteria for the establishment, wherein the one or more criteria comprises one or more of (i) a work-task completion criteria, (ii) a work-task priority criteria, or (iii) a work-task availability criteria.

17. The method of claim 15, wherein each work task of the set of work tasks comprises (i) a fulfillment task comprising a series of two or more fulfillment actions for fulfilling orders, (ii) a replenishment task comprising a series of two or more replenishment actions for replenishing stock of one or more items at the establishment, or (iii) a mixed task comprising at least one fulfillment action and at least one replenishment action.

18. The method of claim 15, wherein, for each candidate combination from the set of candidate combinations, determining the optimization metric based on the plurality of task locations of each work task of the candidate combination comprises determining the optimization metric based on one or more task locations that are not common to each work task of the candidate combination.

19. The method of claim 15, wherein each candidate combination comprises two work tasks from the set of work tasks, and wherein generating the set of candidate combinations comprises:
generating the set of candidate combinations based on populating a multi-dimensional data structure with candidate combinations of two work tasks from the set of work tasks.

20. The method of claim 19, wherein the multi-dimensional data structure comprises a metric entry for each candidate combination of two work tasks, and wherein generating the set of optimization metrics comprises:
generating the set of optimization metrics based on populating, for each candidate combination of two work tasks, the metric entry with an optimization metric
